(19) United States
(12) Patent Application Publication
(10) Pub. No.: US 2016/0316831 A1
(43) Pub. Date: Nov. 3, 2016

(54) FASHIONABLE VERSATILE MASK GARMENT RETAINS A FILTER ELEMENT IN A CONCEALED STATE

(71) Applicant: Shireen Noelle Yarahmadi, Alameda, CA (US)

(72) Inventor: Shireen Noelle Yarahmadi, Alameda, CA (US)

(21) Appl. No.: 14/701,487

(22) Filed: Apr. 30, 2015

(51) Int. Cl. A41D 13/11; A62B 23/02; A41D 27/08

(52) U.S. Cl. CPC A41D 13/1153; A41D 27/08; A41D 13/1161; A62B 23/025

(57) ABSTRACT

A fashionable versatile mask garment made of a plurality of layered materials conceals a respiratory filter element releasably retained within, and as part of the garment, to protect a wearer's nose and mouth from airborne particulates. Two right and left upper straps and two right and left lower connectors extend outwardly from each of the opposing side edges, contain engaging mechanisms to secure garment at the wearer's lower-face, head, and neck. For versatility in purpose, the mask garment is adaptable from a first alternative position as a mask, into a second alternative position as a neck warmer, or a third alternative position as a head cover, while continuing to contain the filter element in a concealed state so as to be accessible to a wearer at a moment's notice. Its function as a fashionable versatile mask garment with a concealable capability, is accomplished by using design methods, sewing techniques, embellishment and fabric applications common to casual and professional fashion attire.

### DETAILED DESCRIPTION OF PRESENT DISCLOSURE

In this detailed description, the following terms generally have the following meanings:

The term “fastening mechanism” refers to and defines an area of releasable attachment. The fastening mechanisms, and/or fastening connectors, and/or fasteners enable securing of the mask garment to reconfigure the lower-face and neck area into a closed configuration until the fastening mechanisms, and/or fastening connectors, and/or fasteners are separated. An fastening mechanisms, and/or fastening connectors, and/or fasteners may comprise one or more releasable coupling, fasteners, and/or fastening mechanisms, e.g., hooks, loops, bulbs, mushrooms, arrowheads, balls on stems, buttons, snaps, magnetic disks, cohesives, selective adhesives, etc. Fastening mechanisms, and/or fastening connectors, and/or fasteners comprise those elements of an fastening, coupling and/or mating system that form the area of releasable attachment via direct surface-to-surface contact forming an fastening mechanism, and/or fastening connector, and/or fastener closure. For the purpose of clarity, surface-to-surface contact encompasses contact between a surface of a hook material and a surface of a loop material, for example. The fastening mechanisms, and/or fastening connectors, and/or fasteners may be the hooks or the loops that are joined and connect with the other fastening mechanisms, and/or fastening connectors, and/or fasteners on a component comprised in mask garment, or on a portion of the mask garment.

The term “approximately” as used herein may be applied to modify any quantitative representation that could permissibly vary without resulting in a change in the basic function to which it is related.

As used herein, the term “visual signal” refers to a component that designates the visual signal comprising one or more structural, graphical, or textural element locations, in this instance, a placement pad location for a wearer to align a filter element adjacent a retainer means.

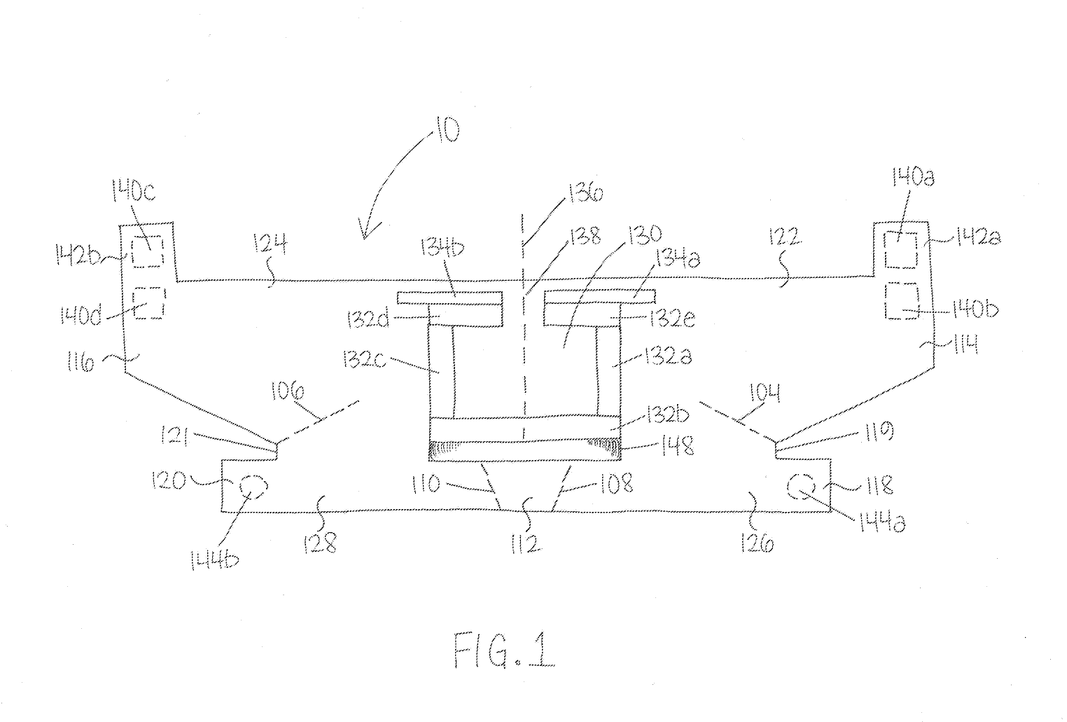

Reference will now be made in detail to the various components used to form the present disclosure and non-limiting embodiments, of which one or more examples illustrated in the drawings FIGS. 1-10. Each example is provided by way of explanation of the disclosure and is not meant as a limitation of the disclosure. For example, features illustrated and described as part of one embodiment or position can be used on another embodiment or position to yield yet another embodiment. It is intended that the present disclosure include such modifications and variations.

Mask Garment

In one embodiment, referring now to FIG. 1, shows a perspective view of the present disclosure in an unfolded and generally flattened configuration. A mask garment 10 is in a generally trapezoidal shape wherein the dimensions from a right upper strap end 114, to a left upper strap end 116 are longer than the dimensions from a right connector end 118 to a left connector end 120. Both right and left upper strap ends 114, 116 and right and left connector ends 118, 120 are formed unitarily and extend away from an opposing right side edge 119 and an opposing left side edge 121 of mask garment 10. Additionally, a right tab extension 142a is unitarily comprised on right upper strap end 114, and a left tab extension 142b is unitarily comprised on left upper strap end 116. Right upper strap end 114 and left upper strap end 116 are designed to fit around the sides of a wearer's face and join at the back of a wearer's head, wherein right and left connector ends 118, 120 are designed to fit around a front and lower neck of a wearer to join at the back of a wearer's neck.

Generally, as used herein, an upper right edge 122 and an upper left edge 124 will refer to that portion of mask garment 10 which is in proximity to and contacts a wearer's nose bridge area, cheeks, below the temples, ears, and extends to the back of a wearer's head. As used herein, a lower right edge 126 and a lower left edge 128 will refer to that portion of mask garment 10 which is in proximity to and contacts the front and lower neck area of the wearer.

As is illustrated in FIG. 1 mask garment 10 encompasses three fastening points 101, 102, and 103 of which first fastening point and second fastening point are comprised with fastening mechanisms at the back of a wearer's head, and a third fastening point is comprised with fastening mechanisms at the back of a wearer's neck.

In one embodiment, as illustrated in FIG. 1, a right tab extension 142a is unitarily attached at a first fastening point 101 on right upper edge 122 of right upper strap end 114, and a left tab extension 142b is unitarily attached at a second fastening point 102 on the left upper edge 124 of left upper strap end 116 for fastening at the back of the wearer's head. Right and left tab extensions 142a, 142b, are from approximately 2 inches in width and approximately 2 inches in length and made of the same plurality of supple materials as mask garment 10. It should be appreciated that in other various non-limiting embodiments, right and left tab extensions 142a, 142b, can be unitarily or non-unitarily constructed and/or adjoined with one or more suitable fabric materials and/or different material compositions. It should be further appreciated that right and left tab extensions 142a, 142b can be of other suitable width and length dimensions.

In one embodiment, the entire mask garment 10 when unfolded and generally flattened may be in dimensions from approximately 33 inches to approximately 17 inches in width, from right upper and left upper strap ends 114, 116 and from approximately 15 inches to approximately 5 inches in length from right upper and left upper edges 122, 124 to right lower and left lower edges 126, 128. Those skilled in the art will recognize that mask garment 10 may be made in various sizes to fit children, teenagers, and adults of different head and neck dimensions.

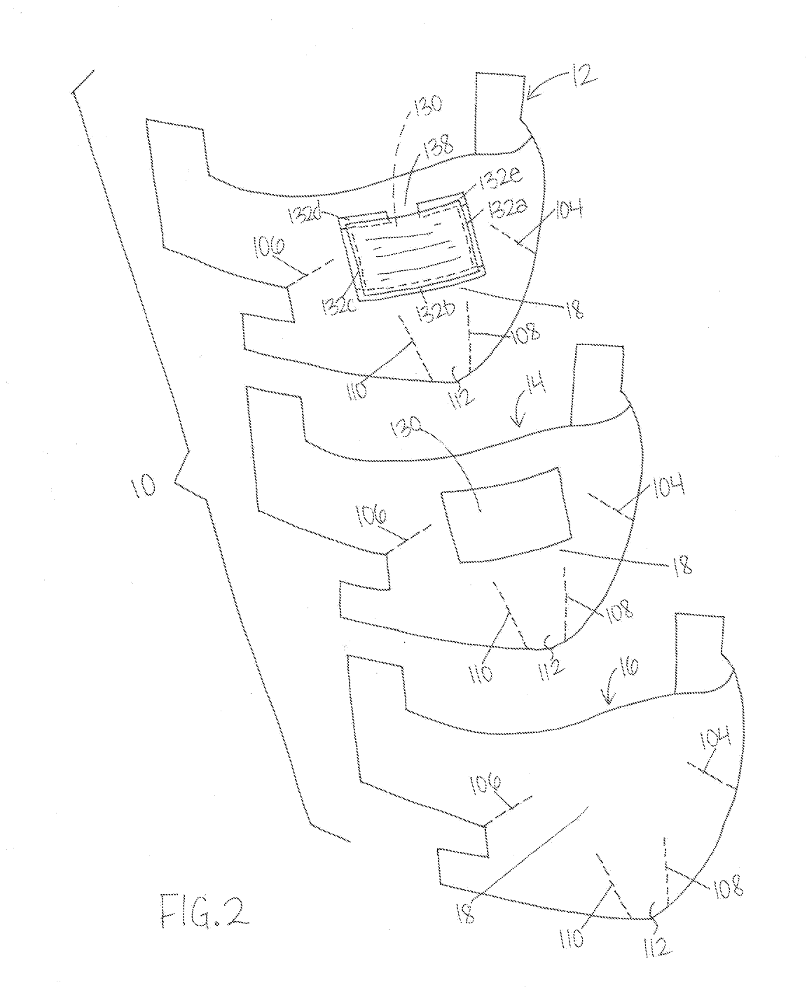

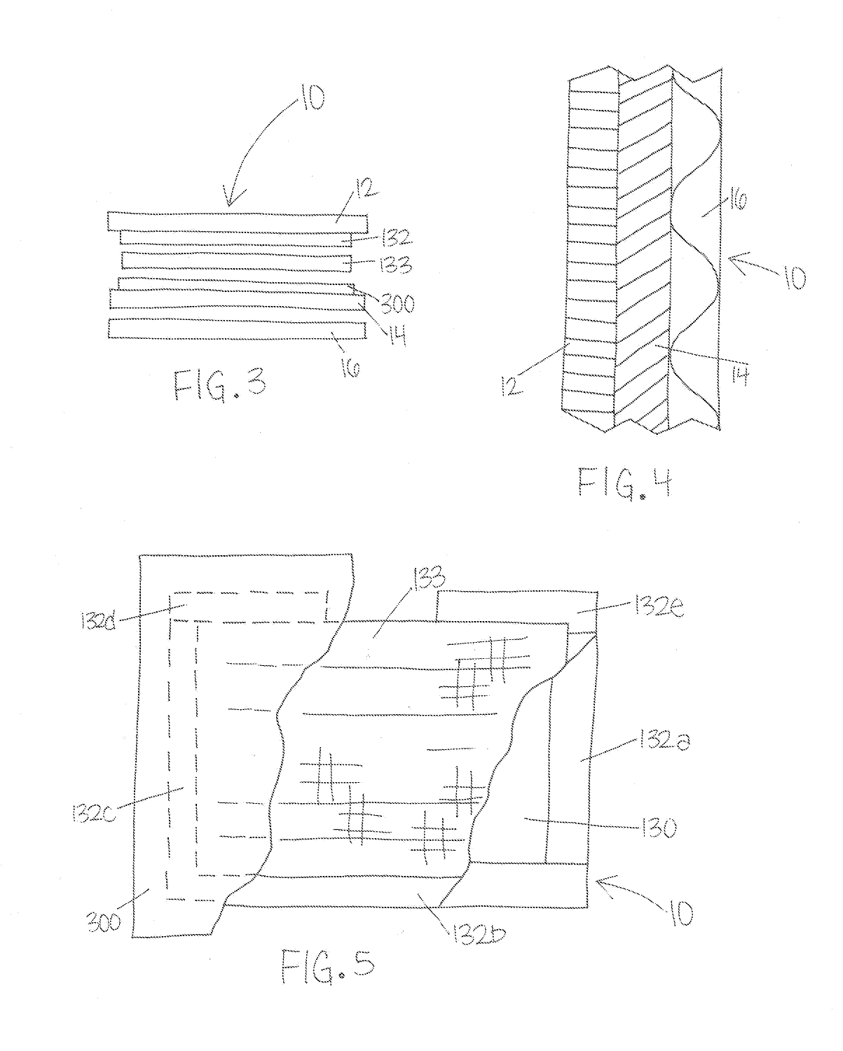

In one embodiment, referring now to FIG. 2, mask garment 10 has an inner fabric layer 12, desirably of a soft fabric, such as a flannel or fleece, for providing a soft, comforting, and non-irritating surface against the wearer's skin, and an outer fabric layer 16, which is desirably a lightweight air permeable fabric to provide for passage of air without undue resistance to the wearer. To provide further durability, concealment, and to act as a non-engagement zone to VELCRO™, an inter-between fabric layer 14, desirably a non-woven fabric and/or snag-resistant fabric material, such as polyester, is sandwiched throughout its entirety, between inner layer 12 and outer layer 16, as illustrated in a fragmentary sectional view in FIG. 4. It should be appreciated that in various non-limiting embodiments, inter-between layer 14 may be suitably constructed in certain particular areas of mask garment 10, and not necessarily throughout its entirety.

Regarding FIGS. 1 and 2, inner base of inner layer 12, inter-between base of inter-between layer 14, and outer base of outer layer 16 are joined together at the peripheral edges, such as by sewing or adhesive bond, or otherwise incorporated, wherein reverse side of said outer layer 16 is proximate to a portion of the obverse side of said inter-between layer 14, and reverse side of said inner layer 12, is proximate to a portion of the reverse side of inter-between layer 14, thereby forming a unitary base region 18′. This plurality of layered construction is shown in a fragmentary sectional view in FIG. 4, although it should be appreciated that in various non-limiting embodiments, mask garment 10 may be constructed and fabricated with two or more layers of fabric materials. It should be further appreciated that mask garment 10 may be of different pieces of fabrics selectively attached and can be made in various colors and/or designed prints to aid in constructing the mask garment. Mask garment 10 may be constructed as a substantially unitary mask garment; alternatively, any portion of mask garment 10, may be further adjoined and/or may include one or more sections therein, made from one or more suitable fabric materials, including, but not limited to, cotton, jersey, silk, or any suitable combination thereof. Materials can be further insulating or non-insulating depending on climatic conditions and a wearer's particular use of the mask garment, and may include, without limitation, may be constituted of natural, man-made or manufactured material, or a composite thereof, may be plain or treated material, may be woven or non-woven cloth, and may be constituted of a hydrophobic material, a hydrophilic material, or a hygroscopic material or may be a functional combination of two or more layers of hydrophobic, hydrophilic, or hygroscopic materials. Mask garment 10 may be constituted of unilayer cloth or multilayer cloth, and may be generally soft and flexible.

Central Opening

In one embodiment, as illustrated in FIGS. 1, 2, and 8, a central opening 130′ is formed in mask garment 10 by the removal of an approximate 5″×2″ rectangular shaped fabric material cut out from a portion of center base 18′ of both inner layer 12 and inter-between layer 14, at the approximate point where a wearer's nose and mouth reside. A first central opening 130′ is formed in inner layer 12 and a second central opening is formed in inter-between layer 14. First central opening 130′ in inner layer 12 and second central opening 130′ in inter-between layer 14 are constructed in order to allow air space and provide breathability without substantial resistance when the wearer utilizes a releasable filter element 133 retained at first central opening 130′. Unitary base 18′ contains and holds filter 133 in correspondence with a wearer's nose and mouth. It is to be appreciated that central opening 130′ may be formed by removal of fabric materials in other predetermined size and/or shape dimensions and/or configurations.

Mask garment 10 comprises fastening mechanisms to serve as a fastening retainer for filter 133, desirably comprised of industrial strength hook strip fasteners, for example, VELCRO™ for receiving filter 133 positioned away from a wearer's face. Hook strip fasteners 132a, 132b, 132c, 132d, and 132e are adhered, such as by threaded stitch or adhesive bond, or otherwise incorporated, and are collectively formed of hooks of hook and loop fasteners in dimensions from ½″ to 1″ in width and in an approximate dimension of 6″×3″ frame surrounding remaining edges of first central opening 130′ on reverse side of inner layer 12, to which reverse side of inter-between layer 14 now abuts, and reverse side of outer layer 16 fully covers, as is illustrated in FIG. 2.

Surprisingly, the application of hook strip fasteners 132a, 132b, 132c, 132d, and 132e surrounding the remaining edges of first central opening 130′ on reverse side of layer 12 provides an excellent retaining means when filter 133 is desirably comprised of, or having attached thereto, by sewn stitch or adhesive bond, or otherwise, a fabric(s) and/or cloth material(s) with a comparable loop composition that mimics the loop side to which hook strip fasteners will (by design) automatically attach. The use of hook strip fasteners 132a, 132b, 132c, 132d, and 132e to sufficiently retain filter 133 over a nose and mouth of a wearer, and whereby eliminates the use of ear loops and head ties typically associated with conventional facemasks (not shown).

Due to the semi-rigid composition of industrial hook fasteners 132a, 132b, 132c, 132d, and 132e, the hook fasteners serve to create a structural semi-rigid hook retainer frame 132′ encompassing the surrounding edges of first central opening 130′ formed in inner layer 12. Hook retainer frame 132′ that holds filter 133 in correspondence with a wearer's nose and mouth at unitary base 18′. It is to be appreciated that hook retainer frame 132′ may be comprised in other suitable dimensions and shapes, other than rectangular, for instance, hook -retainer frame 132′ may be comprised of a larger or of a smaller dimension, of course, depending on the dimensions and shape of first central opening 130′ formed in inner layer 12.

Filter Element

Filter 133 of the present disclosure may be of any fabric suitable for filtering out one or more types of airborne particles, gasses, or biological agents. The filter fabric may be of a woven or non-woven material. The filter fabric may be made of natural fibers, such as cotton or wool, or may be made from synthetic fibers such as polyester and polyurethane and/or synthetic foam materials. The filter fabric can be designed to filter airborne particles and/or gasses by mechanical mechanisms (e.g. by varying the weave density and/or fabric thickness or in the case of foam materials, the foam density) and/or by chemical mechanisms (e.g. by including absorptive charcoal particles embedded in the fabric and/or foam and/or by treating the fabric and/or foam with absorptive chemicals). Filters constructed as described above are capable of filtering out many common airborne pollutants/particulates such as smoke, dust and dirt. Generally, to remove bacteria and/or viruses from the air, a filter capable of filtering particles as small as 1 to 2 microns is required. Accordingly, the assembly of the layers of the filter fabric, or cloth forms a filter having a designated filtering function. The filtering function can be varied by changing the number of layers used and/or the pore size to one or more of the layers. Such filters are known in the art, certain types of flat pleated surgical masks being one such example (not shown), and are suitable for the present disclosure.

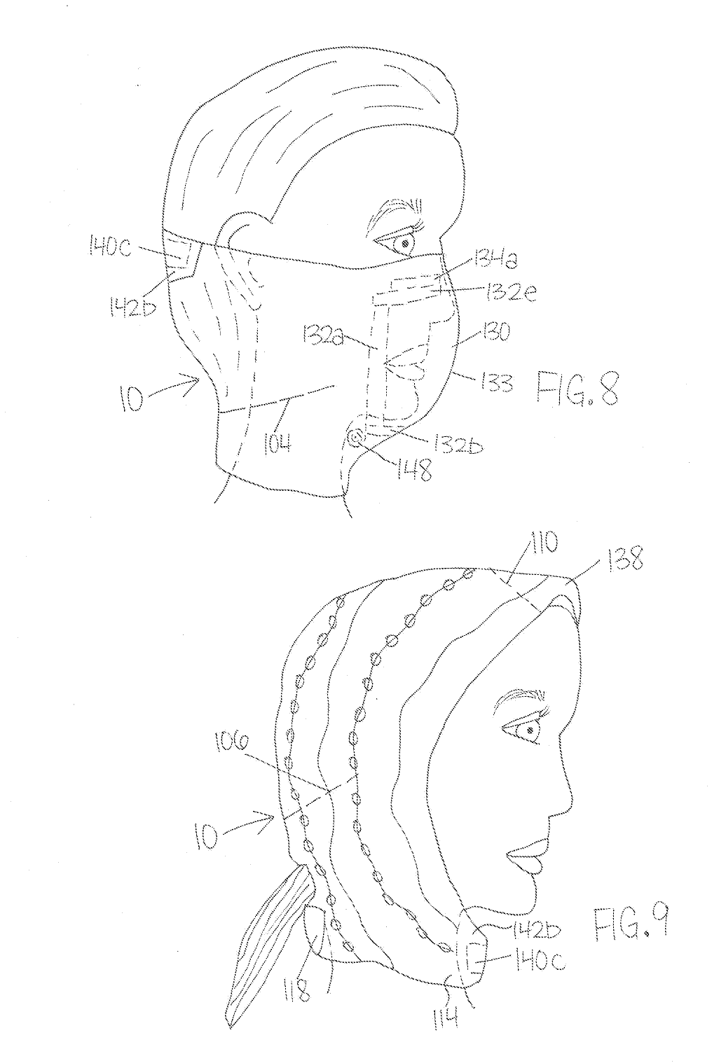

As illustrated in FIGS. 2 and 3, filter 133 is mounted into hook retainer frame 132′, wherein hook strip fasteners and connect in an overlapping surface-to-surface contact at an approximate ¼ to ½ inch distance into all four sides of filter 133, thereby retaining filter 133 sufficiently in place. The semi-rigid hook retainer frame 132′ further provides an extension of filter 133, into a spread position, to span across the wearer's nose-chin-mouth region 112. Hook retainer frame 132′ further positions filter 133 into a tent-like plenum position directed away from the contact points of the wearer's face for a more comfortable wear, as illustrated in FIGS. 8.

Visual Signal Placement Pad

In one embodiment, and now referring to FIG. 5, a placement pad 300 is constructed to provide a visual signal to a wearer indicating a location for the placement and retaining of filter 133 into hook retainer frame 132′. Placement pad 300 comprises one or more structural, graphical, or textural elements, desirably comprised on a non-woven fabric material, and of a color that is distinct from the color of inter-between fabric layer 14. Placement pad 300 is attached by sewing or adhesive bond, or otherwise incorporated onto the reverse side of inter-between fabric layer 14 and to which hook retainer frame 132′ abuts. Placement pad 300, is desirably distinct in color or design so as to provide a visual point for the wearer to position and align filter 133 for placement into hook retainer frame 132′. In various embodiments, placement pad 300 may comprise any suitable indicia for example, graphics, and/or may comprise different patterns, characters, pictorial symbols, drawings and logos, or carry other identifying indicia that provides contrast thereby increasing placement pad 300 visibility to the wearer.

Vapor Rolls

As illustrated in FIGS. 1 and 8, in one embodiment, for further securement of mask garment 10 so as to prevent air leakage at a nose bridge area 138, a right vapor roll piece 134a and a left vapor roll piece 134b are attached by threaded stitch, adhesive bond, or other suitable means, and sandwiched between reverse side of inner fabric layer 12 and reverse side of inter-between fabric layer 14, at center of the right upper and left upper edges 122, 124 and adjacent nose bridge area 138 as illustrated in FIG. 1. Vapor rolls 134a, 134b, are desirably constructed of nylon or any suitable wind resistant material, such as windbreaker material, or a soft-foam. Vapor rolls 134a, 134b may provide a reduced fogging of a wearer's eyeglasses by preventing warm vapor laden air from passing upwards and through the center of right upper and left upper edges 122, 124 of mask garment 10. With the vapor roll feature, and along with the snug fit of the mask, warm moist air is forced in a downward fashion so as to escape from filter 133.

First and Second Fastening Points at the Back of a Wearer's Head

As is illustrated in FIGS. 1 and 7, mask garment 10 encompasses three fastening points, of which a first fastening point 101 and a second fastening point 102 are comprised with fastening means at the back of a wearer's head, with a third fastening point 103 comprised with fastening means at the back of a wearer's neck.

As illustrated in FIG. 1, the first fastening point 101 is located at the back of the wearer's head adjacent right upper strap end 114 and comprised with a first fastening mechanism 140a, attached on the reverse side of inner layer 12, by sewing or bond adhesive, or otherwise incorporated and contained inside of right tab extension 142a, with a second fastening mechanism 140b attached on the reverse side of inner layer 12 by sewing or bond adhesive, or otherwise incorporated onto a portion of right upper strap end 114, and is below and adjacent first fastening mechanism 140a.

The second fastening point 102 at the back of the wearer's head is adjacent a left upper strap end 116 and is comprised with a third fastening mechanism 140c, attached on the reverse side of inner layer 12, by sewing or bond adhesive, or otherwise incorporated and contained inside of left tab extension 142b, with a fourth fastening mechanism 140d attached on the reverse side of inner layer 12 by sewing or bond adhesive, or otherwise incorporated onto a portion of left upper strap end 116, and is below and adjacent third fastening mechanism 140c.

Fastening mechanisms 140a, 1406, 140c, and 140d are desirably comprised of commercially available magnetic disks, wherein first and second fastening mechanisms 140a, 140b, and third and fourth fastening mechanisms 140c, 140d are oriented with a common pole, either the north or the south, in order to be lapped, engaged and fastened. It should be appreciated that mask garment 10, in other various non-limiting embodiments, may comprise different fastening mechanisms, or an fastening mechanism device and/or a different fastening mechanism composition, for example, the fastening mechanisms may comprise fastening mechanism fasteners, other than magnetic disks, for example, fastening mechanisms such as mechanical fasteners, e.g. hook and loop fasteners, hook and hook fasteners, macrofasteners, buttons and button holes, snaps, tab and slot fasteners, hermaphroditic fasteners, hinged clips, and/or any other suitable fastening mechanisms.

In one embodiment, as illustrated in FIGS. 1 and 7, right tab extensions 142a is illustrated in a closed position at the back of a wearer's head, shows left upper edge material 124 clamped between first and second fastening mechanisms 140a, 140b, and further showing right upper edge 122 clamped between third and fourth fastening mechanisms 140c, 140d, due to the magnetic interaction therebetween. The interaction of the magnetic disk fastening mechanisms hold the mask garment 10 in a releasable closed position at a wearer's lower face and at the back of a wearer's head. Fastening mechanisms 140a, 140b, 140c, and 140d allow a certain degree of adjustability for sizing and snugness of mask garment 10 around the lower face and head of a wearer.

Fastening mechanisms 140a, 140b, 140c, and 140d are encapsulated in semi-soft polyvinyl chloride and/or silicone to provide a highly flexible and pliable tab extensions 142a, 142b, further causing fastening mechanisms 140a, 140b, 140c, and 140d to be unaffected by contact with water and should not be degraded with multiple washings. Typically, coupling mechanisms 140a, 140b, 140c, and 140d may be from approximately 1½″×1½″ and a thickness of less than one eighth of an inch, and approximately a sixteenth of an inch, although as can be appreciated, in other various non-limiting embodiments, magnetic disk fastening mechanisms can be of a thickness of more than one eighth of an inch, and more than a sixteenth of an inch and may be in any other suitable strengths, shapes, and size dimensions.

Third Fastening Point at the Back of a Wearer's Neck

Mask garment 10 further comprises the third fastening point 103 in order to secure mask garment 10 at the back of a wearer's neck. As is illustrated in FIGS. 1 and 7, to further secure mask garment 10 at the wearer's lower neck area, a fifth fastening mechanism 144a is attached by threaded stitch or adhesive bond, or otherwise incorporated on a portion of right connector end 118 extending from right side edge 119, wherein a sixth fastening mechanism 144b, is attached by threaded stitch or adhesive bond, or otherwise incorporated, on a portion of a left connector end 120 extending from left side edge 121. Right and left connector ends 118, 120 are further designed to secure and join mask garment at the back of a wearer's neck. Fifth and sixth fastening mechanisms 144a, 144b, are desirably a series of snap adjusters, but alternate fastening mechanisms can be attached with a series of other suitable fastening mechanisms, for example, fifth and sixth fastening mechanisms 144a, 144b may comprise mechanical fasteners, e.g. hook and loop, for example, or hook and hook fasteners, macrofasteners, magnetic disk fasteners, buttons and button holes, tab and slot fasteners, hermaphroditic fasteners, hinged clips, for example, or any other suitable fastening and fastening mechanisms may be used to secure mask garment 10 at the back of a wearer's neck. Fifth and sixth fastening mechanisms 144a, 144b allow a certain degree of adjustability for sizing and snugness of mask garment 10 around the wearer's lower chin and neck region.

Non-engagement Material for Hooks

Along with providing durability for mask garment 10, inter-between fabric layer 14, further serves a second function as a non-engageable fabric material to hook strip fastener frame 132′ when desirably comprised of a non-woven fabric material. Many fabric and/or cloth material constructions are prone to attaching to the hook side of hook and loop fasteners. Hook fasteners can snag, pull, and damage typical fabric materials, and the like, if the material construction mimics the loop side of hook and loop fasteners, to which the hook side will (by design) automatically attach. Inter-between fabric layer 14 serves to correspond with hook strip frame 132′, in order to protect outer fabric layer 16, and/or any other fabric and/or cloth materials of mask garment 10, and/or any other fabric and/or cloth materials that may come into contact and may be susceptible to damage from the hooks of hook strip frame 132′.

Concealment Material for Filter

As illustrated in FIG. 2, along with providing durability, and preventing hook retainer frame 132′ from attaching, snagging and damaging other fabric materials in or around mask garment 10, inter-between fabric layer 14 serves yet a third function and provides for concealment of filter element 133. Inter-between layer 14 is desirably the same congruent color as filter 133 so that when the filter is mounted at hook retainer frame 132′ and seated at second central opening 130′, inter-between layer 14 will serve to blend in with the congruent color of the filter so as to make filter 133 indistinguishable and appear as one and the same of a constructed fabric material when outer layer 16 covers and abuts obverse side of inter-between layer 14.

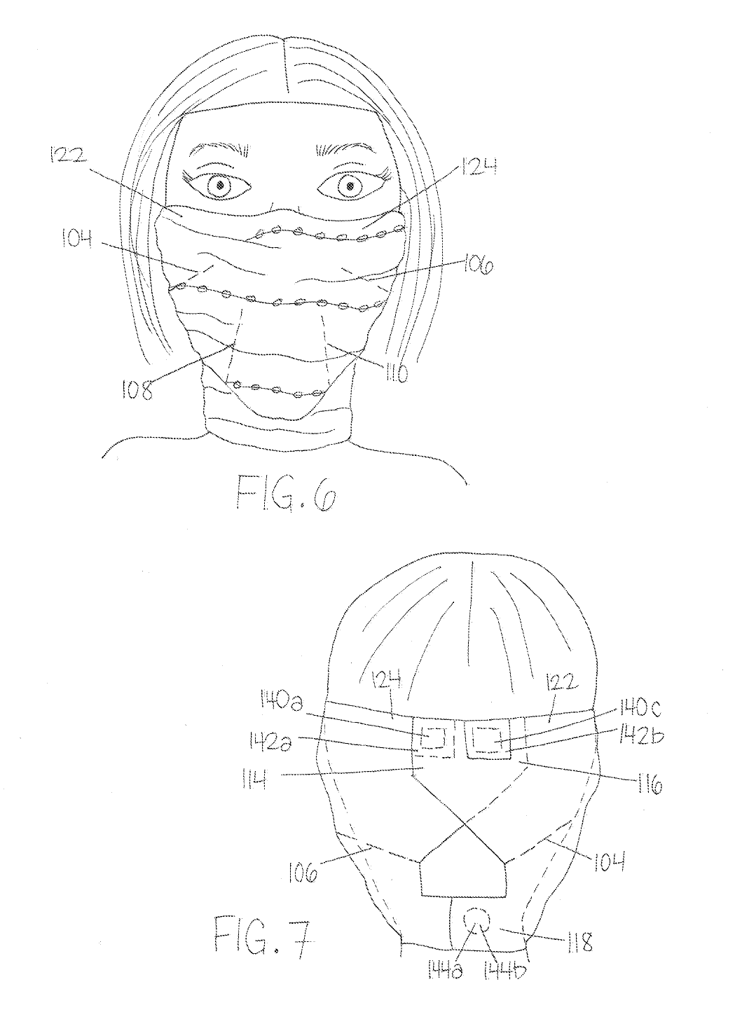

As illustrated in FIGS. 2 and 6, outer layer 16 serves to cover and overlap obverse side of inter-between layer 14, for further concealment of first and second central opening 130′, hook retainer frame 132′, filter 133, placement pad 300 and any other various attachments and/or components comprised inside mask garment 10. As illustrated in FIG. 3, an in-depth fragmentary sectional view shows the plurality of layers 12, 14, 16, and wherein hook retainer frame 132′, filter 133, and placement pad 300 are located within mask garment 10.

Stitched Tapering Folds

As illustrated in FIGS. 1, 2, 6, 7, and 10, prior to assembly, and in order to achieve a more advantageously shaped contoured fit at the sides of the lower-face, cheeks, and at the chin region of a wearer, sewing techniques can be applied. In this instance, for a lean, snug and contoured fit at the sides of the wearer's lower face and cheeks, a right stitched tapering fold 104 and a left stitched tapering fold 106, approximately one inch wide and four inches in length are gathered and sewn into fabric material layers, 12, 14, and 16, adjacent the side edges of hook retainer frame 132′, whereby forming a tapered right cheek pocket region 111a and left tapered cheek pocket region 111b.

As illustrated in FIGS. 1, 2, 6, 8, 9 and 10 two additional stitched tapering folds, a right stitched tapering fold 108 and a left stitched tapering fold 110, are gathered and taken in for a lean, snug and contoured fit at the wearer's lower chin and neck area, approximately one inch wide and three inches in length and gathered and sewn into fabric material layers, 12, 14, and 16, adjacent bottom edge of hook retainer frame 132′ whereby forming a tapered nose-chin-mouth region 112, as illustrated in FIGS. 1 and 2. A snug and contoured fit about the wearer's lower-face, chin and neck regions prevents potential air leakage of inhaled or exhaled air around the edges of mask garment body 10.

Design Method and Embellishment

In one embodiment, and as those skilled in the art of garment manufacturing will understand, the obverse side of outer base layer 16 is desirably comprised with a design method of a shirred and/or crimped application to the fabric material, and desirably a lightweight air permeable fabric material, to allow for breathability when mask garment 10 is worn as a mask garment, although it is to be appreciated that mask garment 10 in other various non-limiting embodiments, may comprise a non-shirred and/or a non-crimped fabric application in way of design. It is further desired that outer fabric layer 16 be adorned with various decorative embellishments 30 that may include beads, designed prints, leather fringe, pearls, crystals, and the like, to enhance the aesthetic appeal and to satisfy different aesthetic desires, as illustrated in FIGS. 6 and 9, although in other non-limiting embodiments, embellishment 30 may not be applied.

Visual Pad for Filter Placement

Now described is the progression of how the filter is placed into hook fastener frame 132′. In order for wearer to locate and place filter 133 in placement pad 300, wearer visually locates placement pad 300, by indicia, desirably in a distinct color and/or design so that wearer can visually locate and correctly align and position filter 133 onto placement pad 300. Once placed and aligned, wearer applies pressure onto obverse side of inner fabric layer 12, wherein hook retainer frame 132′ comprised at first central opening 130′ on reverse side of inner layer 12, cinches and connects in an overlapping surface-to-surface contact at an approximate ¼ inch to ½ inch distance into all four sides of filter 133, and holding and retaining filter 133 sufficiently in place.

Further described is the progression of how mask garment 10 is donned and secured at the back of a wearer's neck.

For an easier donning of mask garment 10, it is desirable that a wearer first secures mask garment 10 and seats the mask at the wearer's lower neck area before beginning the adjustment of first fastening mechanisms 140a, 140b and second fastening mechanisms 140c, 140d at the back of the head.

Further described is the progression of how mask garment 10 is donned and secured at the back of a wearer's head.

As illustrated in FIG. 7, to secure mask garment 10 at the wearer's lower neck area, the soft inner fabric layer 12 is placed in correspondence and brought towards the wearer's lower neck area. Wearer extends right and left connector ends 118, 120 towards the back of the head at wearer's lower neck area, then locates fifth and sixth fastening mechanisms 144a, 144b comprised on right connector end 118 and left connector end 120 and fastens at the back of the neck.

To secure mask garment 10 at the wearer's lower face and head, the wearer locates right and left upper strap ends 114, 116 and disconnects fastening mechanims 140a, 140b, 140c, 140d in right and left tab extensions 142a, 142b and draws central unitary base region 18 and filter 133 towards wearer's nose and mouth and horizontally places nose bridge area 138 at the center of wearer's nose bridge. Wearer extends left upper strap end 116 rearwardly at the left side of the lower face, and brings left strap around to back of the head, and further extends right upper strap end 114 rearwardly at the right side of the lower face and brings right strap around to the back of the wearer's head. Wearer proceeds to crosse right tab extension 142a over to the side of left tab extension 142b to overlap left upper strap end 116 so that right tab extension 142a is now on the opposite side of left tab extension 142b at the back of the wearer's head.

Right tab extension 142a containing first fastening mechanism 140a is folded over left upper edge 124 in a direction towards the wearer's head and tucked down to connect at second fastening mechanism 140b. First and second fastening mechanisms 140a and 140b interconnect by cinching and holding at left upper edge 124 at the back of a wearer's head. Left tab extension 142b is then folded over right upper edge 122 in a direction away from the wearer's head, wherein third and fourth fastening mechanisms 140c and 140d interconnect by cinching and holding at right upper edge 122. FIG. 7 illustrates a rearward view of mask garment 10 in a first position as a mask garment utilizing adjustable fastening mechanisms 140a, 140b, and 140c, 140d at the back of the wearer's head.

First and second fastening mechanisms 140a, 140b and third and fourth fastening mechanisms 140c, 140d provide for incremental sizeability and may also be incrementally adjusted to accommodate for the comfort of the wearer. First and second fastening mechanisms 140a, 140b, and third and fourth fastening mechanisms 140c, 140d can be adjusted and connected in a manner that provides a snug, yet comfortable fit, in order to prevent gapping and/or air leakage in or out of mask garment 10. Furthermore, fastening mechanisms 140a, 140b, and 140c, 140d provide for a quick releasable attachment of upper right strap end 114 and upper left strap end 116 around the wearer's lower-face and head. The wearer can adjust for securement, sizability, and comfort by sliding tab extensions horizontally at upper edges as necessary.

Right tab extension 142a and left tab extension 142b remain folded, cinched, secured, and connected at upper edges 122, 124 until first and second fastening mechanisms 140a and 140b and third and fourth fastening mechanisms 140c and 140d are pulled apart.

Alternative Positions

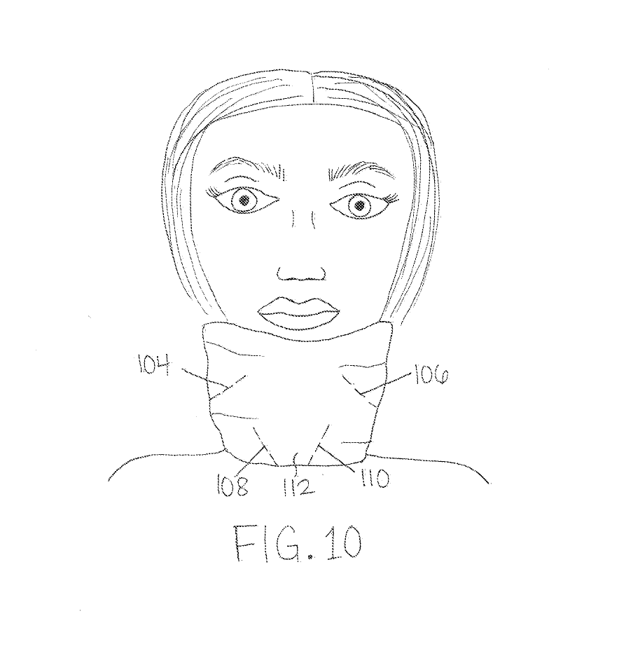

The wearer may desire to adapt mask garment 10 into at least alternative positions such as a neck warmer and a head cover as illustrated in FIGS. 9 and 10, or into a various non-limiting embodiment as a scarf, further illustrated in FIG. 11.

For further warmth and insulation, a wearer may choose to cover central opening 130, when mask garment 10 is adapted into other fashionable positions.

In one embodiment, as illustrated in FIGS. 1 and 5, a central opening cover 148, desirably constructed of the same fabric material as inner fabric layer 12, is connected to mask garment 10 by way of a tethered elastomeric material (not shown), so that there is less likelihood of losing central opening cover 148 and a certainty, that when needed, the cover will be available. For a secure hold at central opening 130, central opening cover 148 can be tucked into and under at all four sides of hook retainer frame 132′ and sandwiched between hook retainer frame 132′ and filter 133. Filter 133 remains attached and retained at hook retainer frame 132′. When wearer desires to adapt mask garment 10 back into a mask to utilize filter 133, central cover opening 148 is easily detachable and can be further stowed within chin pocket area 112, as illustrated in FIG. 8.

Referring now to FIG. 9, alternatively, mask garment 10 may be further adapted into a second alternative position as a head cover in accordance with one non-limiting embodiment, for warmth and for the security of having protective filter 133 accessible when the need may be warranted. In order to configure mask garment 10 into a head covering, wearer holds right upper strap end 114 in one hand, and left upper strap end 116 in the other with right and left tab extensions 142a, 142b in an opened position. With first and second fastening mechanisms 140a, 140b on the right and third and fourth fastening mechanisms 140c, 140d on the left, tab extensions 142a, 142b are placed under the wearer's chin area where first fastening mechanism 140a onto fourth fastening mechanism 140d and third fastening mechanism 140c onto second fastening mechanism 140b and fastened. Right and left connector ends 118, 120 are then adjoined at the back of the head near the lower neck of a wearer, with fifth and sixth fastening mechanisms 144a, 144b fastened for further securement.

Referring now to FIG. 10, alternatively, mask garment 10 may be further adapted into a third alternative position as a neck warmer in accordance with one non-limiting embodiment, for warmth and for the security of having protective filter 133 accessible when the need may be warranted.

In order to configure mask garment 10 into a neck warmer, wearer secures and seats mask garment 10 at the lower neck area before beginning the adjustment of fastening mechanisms 140′.

Fastening mechanism 1446 attached on left connector end 120 is joined with right fastening mechanism 144a on right connector end 118. Left upper strap end 116 is then extended rearwardly at a wearer's lower jaw area and brought around the back of the wearer's neck, wherein right upper strap end 114 is extended rearwardly at the side of the wearer's lower jaw area and brought around to the back of the wearer's neck, in which case, wearer further crosses right tab extension 142a over to the side of left tab extension 142b to overlap left upper strap end 116 so that right tab extension 142a is now on the opposite side of left tab extension 142b at the back of the wearer's neck.

Right tab extension 142a containing first fastening mechanism 140a is then folded over left upper edge 124 in a direction towards the wearer's neck and tucked down to connect at second fastening mechanism 1406. First and second fastening mechanisms 140a and 140b interconnect by cinching and holding at left upper edge 124 at the back of the wearer's neck. Left tab extension 142b is then folded over right upper edge 122 in a direction away from the wearer's neck, wherein third and fourth fastening mechanisms 140c and 140d interconnect by cinching and holding at right upper edge 122.

Right tab extension 142a and left tab extension 142b remain folded, cinched, secured, and connected at upper edges 122, 124 until first and second fastening mechanisms 140a and 140b and third and fourth fastening mechanisms 140c and 140d are pulled apart.

One of the many possible examples of when a wearer may desire to utilize the present disclosure as a mask garment 10 is when a wearer is on his or her way to work and using a form of mass transit and faced with being enclosed inside of a train car in tight quarters with individuals who may be showing signs of illness, for example, coughing and/or sneezing. In such a situation, a wearer may very well choose to protect themselves from such airborne particulates. In this instance, the wearer adjusts and securely connects the fastening mechanisms and neck connector at the back of the wearer's lower neck and head, whereby may quickly access and use the readily available filter 133 within mask garment 10 in an inconspicuous manner. Mask garment 10 should remain in position while the wearer continues his or her ordinary commuting activities. In the alternative, mask garment 10 may be deployed when a wearer may be experiencing signs of illness. A wearer can utilize mask garment 10 so as to have a soft, warm, and comforting mask garment to place against the wearer's lower-face and neck and use the readily available filter 133 to protect others from such airborne particulates.

Further, it should be appreciated that the benefits of the present disclosure are not limited to any particular style or configuration.

The various non-limiting embodiments of the present disclosure described above are for purposes of illustration only and the various modifications and changes of these embodiments can be made without departing from the spirit and scope of the disclosure and without diminishing its intended advantages. It is therefore intended that such modifications and changes be covered by the appended claims hereto.

The disclosure claimed is:

1. A mask garment for a wearer, comprising
an outer layer having an outer obverse side and an outer reverse side, the outer layer having an outer base; an upper edge, a lower edge, and opposing side edges;
an inner layer having an inner obverse side and an inner reverse side, the inner layer having an inner base, an upper edge, a lower edge, and opposing side edges, wherein a portion of the inner base of the inner layer is removed to form a central opening cut in predetermined dimensions therethrough;
an inter between layer having an obverse side and an inter between reverse side, the inter between layer having an inter between base, an upper edge, a lower edge, and opposing side edges, wherein a portion of the inter between base of the inter between layer is removed to form a central opening cut in predetermined dimensions therethrough;
wherein a portion of the outer base reverse side is proximate to a portion of the inter between base obverse side and a portion of the inner base reverse side is proximate to a portion of the inter between base reverse side, wherein peripheral edges of the inner layer, the outer layer, and the inter between layer are attached and form a unitary base portion configured to be placed over a lower-face to enclose a nose and mouth of a wearer;
a right upper strap having a free end configured to extend around at least a portion of the right side of a wearer's head, and
a left upper strap having a free end configured to extend around at least a portion of the left side of a wearer's head;
a right tab extension formed on a portion of the right upper strap;
a left tab extension formed on a portion of the left upper strap;
a lower right connector having a free end configured to extend around at least a portion of the right side of a wearer's neck; and
a lower left connector having a free end configured to extend around at least a portion of the left side of a wearer's neck;
at least three fastening points
wherein a first fastening point comprises a first fastening mechanism and a second fastening mechanism attached on the reverse side of inner layer of the mask garment wherein the first fastening mechanism is positioned and attached inside a right tab extension above second fastening mechanism positioned and attached on the right upper strap adjacent and below the first fastening mechanism and are configured to be releasably attached at the back of a wearer's head;
wherein a second fastening point comprises a third fastening mechanism and a fourth fastening mechanism attached on the reverse side of inner layer of the mask garment wherein the third fastening mechanism is positioned and attached inside a left tab extension above fourth fastening mechanism positioned and attached on left upper strap adjacent and below the third fastening mechanism, and are configured to be releasably attached at the back of the wearer's head;
wherein a third fastening point comprises fifth fastening mechanism disposed on a portion of the lower right connector, and a sixth fastening mechanism disposed on a portion of lower left connector on the same surface of reverse side of inner layer, such that the fifth fastening mechanism and sixth fastening mechanism are configured to be fastened and releasably attached at the back of a wearer's neck;
wherein securement of the fastening mechanisms comprised at first, second, and third fastening points causing the right upper strap to be releasably attached with the right tab extension over left upper edge of the mask garment at the back of a wearer's head, and causing the left upper strap to be releasably attached with the left tab extension over right upper edge of the mask garment at the back of the wearer's head, and causing lower right connector to be releasably attached with lower left connector at the back of the wearer's neck, whereby securing at the wearer's lower face and enclosing the nose and mouth;
a filter element;
a filter retainer;
wherein the mask garment may alternatively be positioned as a head covering, and wherein the mask garment may further alternatively be positioned as a neck warmer.

2. The mask garment according to claim 1, wherein the outer layer is selected from a group of a lightweight air permeable fabric materials so as to provide unobstructed breathability to a wearer.

3. The mask garment of claim 1, further comprising an ornamental embellishment applied to the obverse side of the outer layer.

4. The mask garment of claim 1, wherein the inner layer is selected from a group of a soft flannel or fleece fabric material.

5. The mask garment of claim 1, wherein the inter between layer is selected from a group of non-woven fabric materials non-engagable to hook fasteners.

6. The mask garment of claim 1, further comprising a visual signal comprising one or more structural, graphical or textural elements attached to the reverse side of inter between layer.

7. The mask garment of claim 1, wherein the fastening mechanisms for the first and second fastening points are selected from the group consisting of snaps, buttons and button holes, magnetic disk components, and mechanical hooks and loops, for releasable attachment of the mask garment at the back of a wearer's head.

8. The mask garment of claim 1, wherein the fastening mechanisms for the third fastening point are selected from the group consisting of snaps, buttons and button holes, magnetic disk components, and mechanical hooks and loops, for releasable attachment of the mask garment at the back of a wearer's neck.

9. The mask garment of claim 1, further comprising a right vapor barrier roll and a left vapor barrier roll attached to a portion of reverse side of the inter between layer.

10. A mask garment according to claim 1, wherein retainer for holding the filter element comprises a releasably attachable fastening system of hooks of hook and loop fasteners, comprised of at least one of bulbs, mushrooms, arrowheads, balls on stems, and combinations thereof, for retaining filter element over central opening and holding filter element in a spread position over a wearer's mouth and nose.

11. A mask garment according to claim 1, wherein the filter element includes a plurality of layers of filter materials configured to be placed over the nose and mouth of a wearer to protect a wearer from airborne particulates.

12. A mask garment for a wearer, comprising
an outer layer having an outer obverse side and an outer reverse side, the outer layer having an outer base; an upper edge, a lower edge, and opposing side edges, wherein an ornamental embellishment is applied to the obverse side of outer layer
an inner layer having an inner obverse side and an inner reverse side, the inner layer having an inner base, an upper edge, a lower edge, and opposing side edges, wherein a portion of the inner base of the inner layer is removed to form a central opening cut in predetermined dimensions therethrough;
an inter between layer having an obverse side and an inter between reverse side, the inter between layer having an inter between base, an upper edge, a lower edge, and opposing side edges, wherein a portion of the inter between base of the inter between layer is removed to form a central opening cut in predetermined dimensions therethrough, further comprising an area in the mask garment wherein a visual signal is comprised of one or more structural, graphical or textural elements attached to the reverse side of inter between layer and corresponding with the filter retainer;
wherein a portion of the outer base reverse side is proximate to a portion of the inter between base obverse side and a portion of the inner base reverse side is proximate to a portion of the inter between base reverse side, wherein peripheral edges of the inner layer, the outer layer, and the inter between layer are attached and form a unitary base portion configured to be placed over a lower-face to enclose a nose and mouth of a wearer;
a right upper strap having a free end configured to extend around at least a portion of the right side of a wearer's head, and
a left upper strap having a free end configured to extend around at least a portion of the left side of a wearer's head;
a right tab extension formed on a portion of the right upper strap;
a left tab extension formed on a portion of the left upper strap;
a lower right connector having a free end configured to extend around at least a portion of the right side of a wearer's neck; and
a lower left connector having a free end configured to extend around at least a portion of the left side of a wearer's neck;
at least three fastening points
wherein the first fastening point comprises a first fastening mechanism and a second fastening mechanism attached on the reverse side of inner layer of the mask garment wherein the first fastening mechanism is positioned and attached inside a right tab extension above second fastening mechanism positioned and attached on the right upper strap adjacent and below the first fastening mechanism and are configured to be releasably attached at the back of a wearer's head;
wherein the second fastening point comprises a third fastening mechanism and a fourth fastening mechanism attached on the reverse side of inner layer of the mask garment wherein the third fastening mechanism is positioned and attached inside a left tab extension above fourth fastening mechanism positioned and attached on left upper strap adjacent and below the third fastening mechanism, and are configured to be releasably attached at the back of the wearer's head;
wherein the third fastening point comprises fifth fastening mechanism disposed on a portion of the lower right connector, and a sixth fastening mechanism disposed on a portion of lower left connector on the same surface of reverse side of inner layer, such that the fifth fastening mechanism and sixth fastening mechanism are configured to be fastened and releasably attached at the back of a wearer's neck;
wherein securement of the fastening mechanisms comprised at first, second, and third fastening points causing the right upper strap to be releasably attached with the right tab extension over left upper edge of the mask garment at the back of a wearer's head, and causing the left upper strap to be releasably attached with the left tab extension over right upper edge of the mask garment at the back of the wearer's head, and causing lower right connector to be releasably attached with lower left connector at the back of the wearer's neck, whereby securing the garment at the wearer's lower face and enclosing the nose and mouth,
a filter element includes a plurality of layers of filter materials configured to be placed over the nose and mouth of a wearer to protect a wearer from airborne particulates;
a filter retainer
at least two vapor rolls attached to the reverse side of inter between layer to prevent leakage in and out of the mask garment and prevent potential fogging of a wearer's eyeglasses,
wherein the mask garment may alternatively be positioned as a head covering,
and wherein the mask garment may further alternatively be positioned as a neck warmer.

13. A mask garment of claim 2, wherein vapor rolls comprise a non-woven fabric, nylon, windbreaker material, or foam.

14. A method for donning the mask garment in a first position, comprised of:
first holding the lower right connector end of garment in one hand and holding the lower left connector end in another hand in an open position with inner layer facing towards wearer,
extending the lower right connector end around the right side of a wearer's head, to the back of a wearer's neck,
further extending the lower left connector end of the garment around the left side of a wearer's neck, to the back of a wearer's neck,
securing at the wearer's lower neck with fastening mechanisms;
next holding the left upper tab extension in one hand and holding the right tab extension in another hand in an open position with inner layer facing towards wearer,
positioning the mask garment so that the nose bridge area is horizontally centered on the wearer's nose bridge,
extending the right upper strap end of the mask garment around the right side of a wearer's head, to the back of a wearer's head,
further extending the left upper strap end of the mask garment around the left side of a wearer's head, to the back of a wearer's head,
with the right upper strap end overlapping the left upper strap end,
folding the right tab extension towards the direction of the wearer's head and over the left upper edge of the left upper strap end so that the first fastening mechanism contacts the second fastening mechanism, cinching the upper edge of the left strap end between first fastening mechanism and the second fastening mechanism,
further folding the left tab extension in a direction away from the wearer's head over the right upper edge of the right upper strap end so that the third fastening mechanism contacts the fourth fastening mechanism cinching the upper edge of right strap end between third fastening mechanism and the fourth fastening mechanism,
sliding tabs horizontally at the upper edges as necessary to adjust for securement, sizability, and comfort.
